(19) United States
(12) Patent Application Publication
(10) Pub. No.: US 2010/0111779 A1
(43) Pub. Date: May 6, 2010

(54) Exhaust treatment device

(75) Inventors: Michael Redmann, East Peoria, IL (US); Guillermo A. Herrera, Washington, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/289,662

(22) Filed: Oct. 31, 2008

(51) Int. Cl. B01D 53/92; F01N 3/00; B01D 53/34

(52) U.S. Cl. 422/179; 60/274; 422/168; 422/173

(57) ABSTRACT

An exhaust treatment device is provided, including an exhaust treatment material and a housing in which the exhaust treatment material is contained. The housing may include a double wall substantially surrounding the exhaust treatment material. In addition, the double wall may include an inner wall and an outer wall, the outer wall having an inner surface that is polished.

### TECHNICAL FIELD

The present disclosure is directed to an exhaust treatment device and, more particularly, to an exhaust treatment device including a housing, at least a portion of which is double-walled.

### BACKGROUND

Exhaust systems often include components that operate at relatively high temperatures. For example, exhaust after-treatment components, such as catalytic converters and particulate filters, often include an exhaust treatment material (e.g., the catalyst or the filter material) enclosed in a canister or housing. During operation, the canisters may not only experience relatively high temperatures, but may also transfer thermal energy to nearby objects.

For a number of reasons, it may be desirable to provide such high temperature exhaust treatment devices and yet not have the outer surfaces of such devices become excessively heated. One such reason may be to prevent heat damage of components installed nearby the canister.

Exhaust treatment devices have been developed with features for reducing the transfer of thermal energy to other objects. For example, U.S. Patent Application Publication No. 2007/0238008, issued to Hogan et al., discloses a heat shield for reducing transfer of heat from an exhaust treatment device to an undercarriage of the vehicle.

While the '008 publication provides a heat shield for reducing heat transfer to other vehicle components, the shield does not reduce heat transfer to non-vehicle objects. In addition, while it may be desirable to reduce heat transfer to objects near the exhaust treatment device, it may also be desirable to retain heat within the exhaust treatment device, as many such devices operate well at elevated temperatures. With a heat shield on only one side, the device disclosed in the '008 publication is not particularly well configured for retaining heat.

The present disclosure is directed at improvements in existing thermal transfer reduction technologies for exhaust treatment devices.

### SUMMARY

In one aspect, the present disclosure is directed to an exhaust treatment device including an exhaust treatment material and a housing in which the exhaust treatment material is contained. The housing may include a double wall substantially surrounding the exhaust treatment material. The double wall may include an inner wall and an outer wall, the outer wall having an inner surface that is polished.

In another aspect, the present disclosure is directed to an exhaust treatment device including an exhaust treatment material and a housing in which the exhaust treatment material is contained. At least a portion of the housing may include a double wall, including an inner wall and an outer wall defining therebetween an enclosed space in which there is a substantial vacuum.

In another aspect, the present disclosure is directed to an exhaust treatment device including an exhaust treatment material and a housing in which the exhaust treatment material is contained. At least a portion of the housing may include a double wall, including an inner wall and an outer wall. The device may further include a layer of thermally reflective material affixed to an inner surface of the outer wall.

In another aspect, the present disclosure is directed to an exhaust system including an exhaust treatment device. The exhaust system may include an exhaust conduit configured to carry exhaust gases produced by an exhaust-producing engine, and an exhaust treatment device. The exhaust treatment device may include an exhaust treatment material and a housing in which the exhaust treatment material is contained. The housing may include a double wall substantially surrounding the exhaust treatment material, wherein the double wall includes an inner wall and an outer wall, the outer wall having an inner surface that is polished.

### BRIEF DESCRIPTION OF THE DRAWINGS

FIG. 1 is a diagrammatic, partial cross-sectional illustration of an exhaust system according to an exemplary disclosed embodiment.

FIG. 2 is a diagrammatic, cross-sectional illustration of an exhaust treatment device according to an exemplary disclosed embodiment.

FIG. 3 is a diagrammatic, cross-sectional illustration of an exhaust treatment device according to another exemplary disclosed embodiment.

### DETAILED DESCRIPTION

Reference will now be made in detail to the drawings. Wherever possible, the same reference numbers will be used throughout the drawings to refer to the same or like parts.

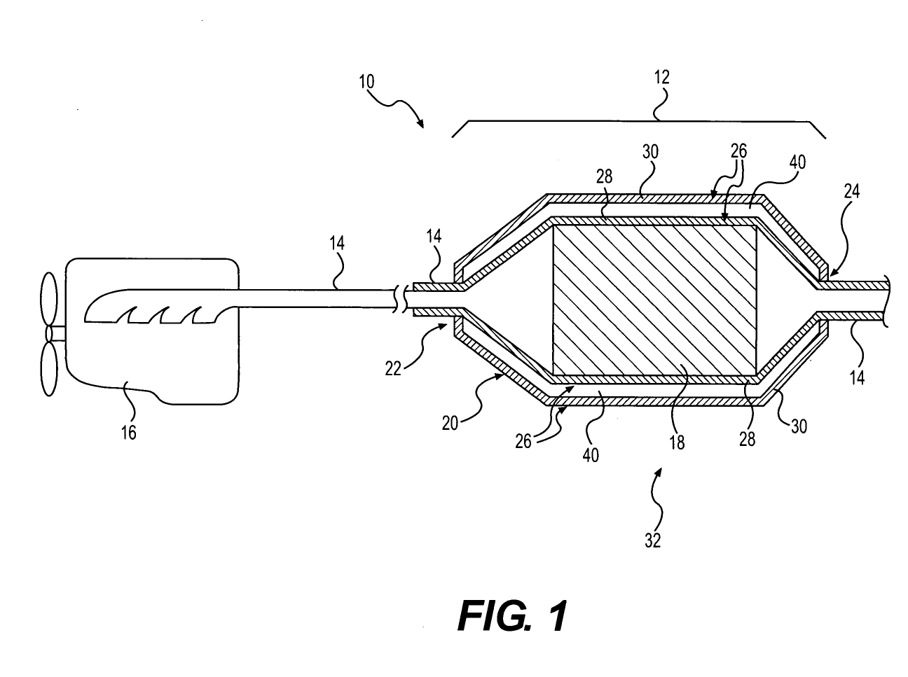

FIG. 1 illustrates an exhaust system 10 including an exhaust treatment device 12. Exhaust system 10 may include an exhaust conduit 14 configured to carry exhaust gases produced by an exhaust-producing engine 16. Exhaust system 10 and engine 16 may be associated with a machine powered by engine 16. Such machines may include mobile machines, such as vehicles (e.g., passenger vehicles, cargo trucks, construction equipment), or stationary machines, such as electrical power generation sets (e.g., an electric power generator driven by a combustion engine). Engine 16 may be any type of exhaust producing engine. For example, engine 16 may be a gasoline, diesel, or gaseous fuel burning engine. Alternatively, engine 16 could be an alternative fuel-burning engine (e.g., ethanol, biodiesel, etc.).

Exhaust treatment device 12 may be an after-treatment device. “After-treatment” is a term commonly used to refer to exhaust treatments, e.g., catalytic conversion or particulate filtration, that are carried out after the exhaust leaves the engine. Exhaust treatment device 12 may include an exhaust treatment material 18 and a housing 20 in which exhaust treatment material 18 may be contained. In some embodiments, exhaust treatment material 18 may include a catalyst. Exhaust treatment material 18 may include any kind of catalyst, including, for example, oxidation catalysts (e.g., a diesel oxidation catalyst or DOC), and/or a reduction catalyst (e.g., a selective catalytic reduction or SCR catalyst). In some embodiments, exhaust treatment material 18 may include a particulate filter. In certain embodiments, more than one exhaust treatment material may be included and/or combined. For example, housing 20 may contain both a catalyst and a particulate filter, or a catalytic particulate filter (e.g., a filter having a coating of catalytic material).

Exhaust treatment device 12 may have an inlet 22 at which the upstream side of exhaust conduit 14 connects to exhaust treatment device 12, and an outlet 24 at which the downstream side of exhaust conduit 14 connects to exhaust treatment device 12. At least a portion of housing 20 may include a double wall 26 including an inner wall 28 and an outer wall 30. In some embodiments, double wall 26 may substantially surround exhaust treatment material 18, as shown in FIG. 1. As also shown in FIG. 1, in some embodiments, double wall 26 may enclose all parts of exhaust treatment device 12 between inlet 22 and outlet 24.

There are three main physical processes by which thermal energy is transferred in such double wall configurations. These three main processes are conduction, convection, and radiation. The disclosed exhaust treatment device may include features that address each of these processes. Exhaust treatment device 12 may include several features that limit the transfer of thermal energy from inner wall 28 of the double-walled structure to outer wall 30. That is, exhaust treatment device 12 may be configured to reduce the transfer of heat from the inside of exhaust treatment device 12 to outer wall 30 of exhaust treatment device 12.

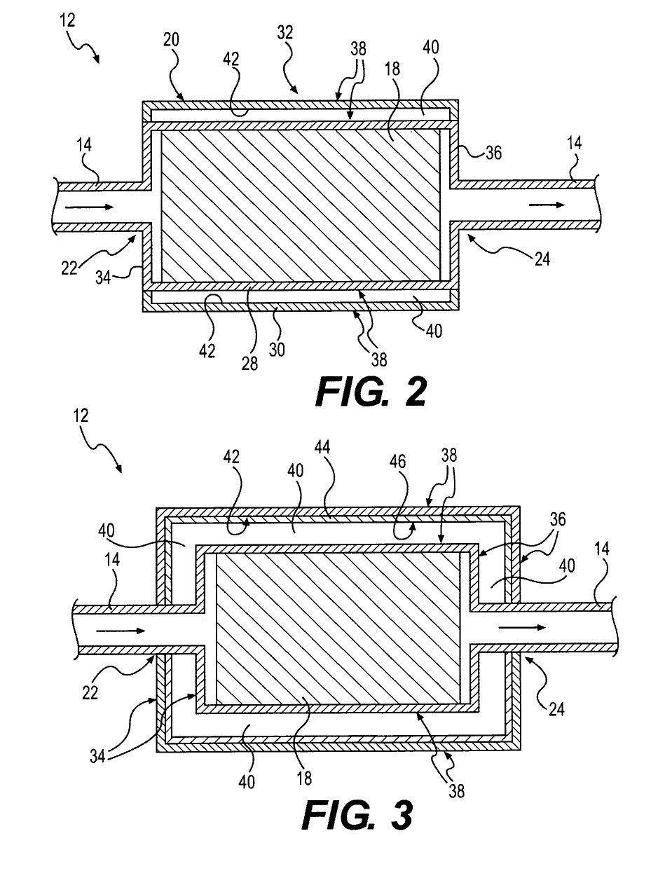

In order to address thermal conduction, exhaust treatment device 12 may have very few physical contact points between outer wall 30 and inner wall 28. In some embodiments, exhaust treatment device 12 may be elongated, as shown in FIG. 1, and may include contact points between inner wall 28 and outer wall 30 only at the ends of exhaust treatment device 12. For example, as shown in FIGS. 2 and 3, housing 20 may include an elongated canister 32, including an upstream end wall 34, a downstream end wall 36, and one or more substantially longitudinal walls 38 connecting upstream end wall 34 to downstream end wall 36. In certain embodiments, longitudinal walls 38 may be double-walled with outer wall 30 being connected to canister 32 only at upstream end wall 34 and downstream end wall 36 of canister 32, as shown in FIG. 2. In other embodiments, longitudinal walls 38, as well as upstream end wall 34 and downstream end wall 36 may all be double-walled, as shown in FIG. 3, thereby fully enclosing canister 32 from inlet 22 to outlet 24.

In some embodiments, inner wall 28 and outer wall 30 may define therebetween an enclosed space 40 in which there is a substantial vacuum. Space 40 may be evacuated to create a substantial vacuum in order to reduce/prevent heat convection. The substantial vacuum in space 40 may be created using any suitable method.

Thermal radiation may be reduced using thermal reflection. For example, an inner surface 42 of outer wall 30 may be configured to be thermally reflective. In some embodiments, inner surface 42 of outer wall 30 may be in order to reflect thermal energy. For purposes of this disclosure, the term “polished” shall refer to a metal surface finish that has a substantially glossy or shiny appearance and provides the surface with increased thermally reflective properties as compared to an unfinished, bare metal surface. In other embodiments, a thermally reflective material may be affixed to inner surface 42 of outer wall 30. Thermally reflective material may be affixed to inner surface 42 of outer wall 30 using, for example, adhesive, fasteners, or other means of attachment. In some embodiments, the thermally reflective material may include a metal foil. In one exemplary embodiment, the thermally reflective material may include a thin layer of fiberglass cloth 44, which may have an aluminized surface 46 (e.g., an aluminum foil), as shown in FIG. 3. Alternatively (or additionally), other thermally reflective materials may be used. In some embodiments, such materials may be coated onto inner surface 42 of outer wall 30 of canister 32.

In some embodiments, a minimal amount of insulating material may be provided in space 40 between inner wall 28 and outer wall 30 (e.g., the aforementioned fiberglass cloth 44). In other embodiments, such insulating material may be omitted.

The various thermal energy transfer reduction features disclosed herein may be embodied in any number of combinations. For example, although the accompanying figures show FIG. 2 having a partial double wall structure and FIG. 3 having a full double wall structure and also a thermally-reflective insulation layer (i.e., fiberglass cloth 44 with aluminized surface 46), embodiments are contemplated that combine a partial double wall structure with a thermally-reflective insulation layer. Also, exhaust treatment device may have any suitable shape and size. While FIG. 1 shows a cylindrical canister 32 having tapered end portions, FIGS. 2 and 3 illustrate cylindrical canisters 32 having squared-off upstream and downstream end walls 34 and 36. However, other shapes are contemplated, such as oval, polygonal, etc. cross-sections.

### INDUSTRIAL APPLICABILITY

The disclosed exhaust treatment device may be applicable to any exhaust treatment system configured to treat the exhaust of an engine. The features of the disclosed exhaust treatment device may be applicable to any high temperature exhaust treatment device. For example, some applications may include housings for exhaust treatment devices such as particulate filters (e.g., diesel particulate filters (DPF's)), catalysts, mufflers, etc. Other exemplary applications may include hydraulics canisters.

The disclosed double wall structure of the disclosed exhaust treatment device may reduce the loss of thermal energy from the exhaust treatment device and, in doing so, may prevent transfer of excessive amounts of thermal energy (and consequent damage and/or other problems) to nearby machine components and/or other objects. In addition, reducing loss of thermal energy may facilitate maintaining the temperature within the exhaust treatment device at a higher level, which may be desirable for some exhaust treatment materials, e.g., catalysts or particulate filters.

In some embodiments, the disclosed double wall structure of the exhaust treatment device may substantially surround the exhaust treatment material. This may protect objects on all sides of the disclosed exhaust treatment device from the transfer of heat from the exhaust treatment device. For example, not only may the disclosed exhaust treatment device be configured to transfer a reduced amount of thermal energy to nearby undercarriage components of a vehicle, but it may also transfer a reduced amount of thermal energy to objects on the ground under the vehicle.

It will be apparent to those having ordinary skill in the art that various modifications and variations can be made to the disclosed exhaust treatment device without departing from the scope of disclosed embodiments. Other embodiments of the disclosed system will be apparent to those having ordinary skill in the art from consideration of the specification and practice of the systems disclosed herein. It is intended that the specification and examples be considered as exemplary only, with a true scope of the disclosed concept being indicated by the following claims and their equivalents.

What is claimed is:

1. An exhaust treatment device, comprising:
an exhaust treatment material;
a housing in which the exhaust treatment material is contained, the housing including a double wall substantially surrounding the exhaust treatment material, the double wall including an inner wall and an outer wall, the outer wall having an inner surface that is polished.

2. The device of claim 1, wherein the inner wall and the outer wall define therebetween an enclosed space in which there is a substantial vacuum.

3. The device of claim 1, wherein the housing includes an elongated canister including an upstream end wall, a downstream end wall, and one or more substantially longitudinal walls connecting the upstream end wall to the downstream end wall, and
wherein the double wall is embodied by the one or more longitudinal walls and an outer wall of the one or more longitudinal walls is connected to the canister only at the upstream end wall and the downstream end wall of the canister.

4. The device of claim 1, wherein the exhaust treatment material includes a catalyst.

5. The device of claim 1, wherein the exhaust treatment material includes a particulate filter.

6. The device of claim 1, including an insulating material between the inner wall and the outer wall.

7. An exhaust treatment device, comprising:
an exhaust treatment material;
a housing in which the exhaust treatment material is contained, at least a portion of the housing including a double wall, including an inner wall and an outer wall defining therebetween an enclosed space in which there is a substantial vacuum.

8. The device of claim 7, wherein the housing includes an elongated canister including an upstream end wall, a downstream end wall, and one or more substantially longitudinal walls connecting the upstream end wall to the downstream end wall, and
wherein the double wall is embodied by the one or more longitudinal walls and the outer wall of the one or more longitudinal walls is connected to the canister only at the upstream end wall and the downstream end wall of the canister.

9. The device of claim 7, wherein the exhaust treatment material includes a catalyst.

10. The device of claim 7, wherein the exhaust treatment material includes a particulate filter.

11. The device of claim 7, including an insulating material between the inner wall and the outer wall.

12. An exhaust treatment device, comprising:
an exhaust treatment material;
a housing in which the exhaust treatment material is contained, at least a portion of the housing including a double wall, including an inner wall, an outer wall, and a layer of thermally reflective material affixed to an inner surface of the outer wall.

13. The device of claim 12, wherein the layer of thermally reflective material includes a metal foil.

14. The device of claim 12, including an insulating material between the inner wall and outer wall.

15. The device of claim 14, wherein the insulating material includes a layer of fiberglass cloth affixed to the inner surface of the outer wall and the thermally reflective material is an aluminized surface of the fiberglass cloth layer.

16. The device of claim 12, wherein the housing includes an elongated canister including an upstream end wall, a downstream end wall, and one or more substantially longitudinal walls connecting the upstream end wall to the downstream end wall, and
wherein the double wall is embodied by the one or more longitudinal walls and an outer wall of the one or more longitudinal walls is connected to the canister only at the upstream end wall and the downstream end wall of the canister.

17. The device of claim 12, wherein the exhaust treatment material includes a catalyst.

18. The device of claim 12, wherein the exhaust treatment material includes a particulate filter.

19. An exhaust system including an exhaust treatment device, comprising:
an exhaust conduit configured to carry exhaust gases produced by an exhaust-producing engine;
an exhaust treatment device including:
an exhaust treatment material; and
a housing in which the exhaust treatment material is contained, the housing including a double wall substantially surrounding the exhaust treatment material, the double wall including an inner wall and an outer wall, the outer wall having an inner surface that is polished.

20. The system of claim 19, wherein the inner wall and the outer wall define therebetween an enclosed space in which there is a substantial vacuum.
